(19) United States
(12) Patent Application Publication
(10) Pub. No.: US 2022/0222752 A1
(43) Pub. Date: Jul. 14, 2022

(54) METHODS FOR ANALYZING INSURANCE DATA AND DEVICES THEREOF

(71) Applicant: Mitchell International, Inc., San Diego, CA (US)

(72) Inventors: Abhijeet Gulati, San Diego, CA (US); Ravi Nemani, San Diego, CA (US); Eric Valenzuela, San Diego, CA (US); Scott Kozak, San Diego, CA (US)

(73) Assignee: Mitchell International, Inc., San Diego, CA (US)

(21) Appl. No.: 17/706,494

(22) Filed: Mar. 28, 2022

Related U.S. Application Data
(63) Continuation-in-part of application No. 17/531,557, filed on Nov. 19, 2021.
Application No. 17/531,557 is a continuation of application No. 16/162,029, filed on Oct. 16, 2018, now abandoned.
(60) Provisional application No. 62/573,013, filed on Oct. 16, 2017.

(51) Int. Cl. G06Q 40/08; G06K 9/62; G06N 20/00; G06F 16/29; G06F 16/9038

(52) U.S. Cl. CPC G06Q 40/08; G06K 9/6218; G06F 16/9038; G06F 16/29; G06N 20/00

(57) ABSTRACT

Vehicle insurance claim data is categorized into a plurality of strata. The categorized vehicle insurance claim data is mapped to corresponding geographic regions and aggregated. When the number of samples in the aggregated data meets a sampling threshold size, the aggregated data is clustered into clusters based on certain criteria and sampled to generate component synthetic peer data sets. A synthetic peer data set is generated by applying a bootstrap aggregation machine learning algorithm on the plurality of component synthetic peer data sets. The performance of a target vehicle insurance company is analyzed by comparing target vehicle insurance claim data of the target vehicle insurance company with the synthetic peer data set. The results of the comparison between the target vehicle insurance claim data and the synthetic peer are presented in a graphical representation.

### CROSS REFERENCE TO RELATED APPLICATIONS

The present application is a continuation-in-part of U.S. patent application Ser. No. 17/531,557, filed Nov. 19, 2021, entitled “METHODS FOR ANALYZING INSURANCE DATA AND DEVICES THEREOF,” which is a continuation of U.S. patent application Ser. No. 16/162,029, filed Oct. 16, 2018, entitled “METHODS FOR ANALYZING INSURANCE DATA AND DEVICES THEREOF,” which claims priority to U.S. Provisional Patent Application No. 62/573,013, filed Oct. 16, 2017, entitled “METHODS FOR ANALYZING INSURANCE DATA AND DEVICES THEREOF,” the disclosures thereof incorporated by reference herein in their entirety.

### DESCRIPTION OF RELATED ART

The disclosed technology relates generally to methods and devices for data management, and more particularly, to methods for analyzing insurance data and devices thereof.

### BACKGROUND

Sales of different types of automobile insurance policies are influenced by various factors related to the vehicle, such as vehicle type, make, model, and year of manufacture. With prior existing technologies, there is no effective technological solution to compare the performance of one carrier to another to provide an unbiased and objective comparison of the insurance data considering all the aforementioned factors. In other words, prior existing technologies are currently unable to identify, obtain and sample data from the rest of the industry carriers in a manner where the sampled data shares the same characteristics of claims distribution for a given carrier whose performance needs to be compared and measured. Additionally, the data that is identified, obtained and sampled in the prior existing technologies does not accurately represent the data that is necessary to compare different insurance carrier. As a result, the evaluation of the performance of the insurance carriers is inaccurate.

### SUMMARY

A method for analyzing data includes obtaining vehicle data from one of the plurality of data sources in a plurality of formats. The obtained vehicle data is aggregated based on one or more geographic locations obtained from one of the plurality of sources. A sampling threshold size is determined for sampling the aggregated vehicle data based on one or more threshold rules. One or more machine learning algorithms are applied to the aggregated vehicle data to generate sampling data when the aggregated vehicle data is greater than the determined sampling threshold size. The generated sampling data is represented in a graphical representation format via a graphical user interface.

A non-transitory computer readable medium having stored thereon instructions for analyzing data comprising machine executable code which when executed by at least one processor, causes the processor to obtain vehicle data from one of the plurality of data sources in a plurality of formats. The obtained vehicle data is aggregated based on one or more geographic locations obtained from one of the plurality of sources. A sampling threshold size is determined for sampling the aggregated vehicle data based on one or more threshold rules. One or more machine learning algorithms are applied to the aggregated vehicle data to generate sampling data when the aggregated vehicle data is greater than the determined sampling threshold size. The generated sampling data is represented in a graphical representation format via a graphical user interface.

An insurance data management computing apparatus including at least one of configurable hardware logic configured to be capable of implementing or a processor coupled to a memory and configured to execute programmed instructions stored in the memory to obtaining vehicle data from one of the plurality of data sources in a plurality of formats. The obtained vehicle data is aggregated based on one or more geographic locations obtained from one of the plurality of sources. A sampling threshold size is determined for sampling the aggregated vehicle data based on one or more threshold rules. One or more machine learning algorithms are applied to the aggregated vehicle data to generate sampling data when the aggregated vehicle data is greater than the determined sampling threshold size. The generated sampling data is represented in a graphical representation format via a graphical user interface.

This technology provides a number of advantages including providing a method, non-transitory computer readable medium, and apparatus that effectively assists with analyzing insurance and vehicle data. The disclosed technology is able to effectively use data from different insurance carriers in different formats to generate data that has been aggregated from accurate samples (or otherwise called synthetic peer data). Using the synthetic peer data, the disclosed technology is able to sample data with the clear understanding that the sampled data must share the same characteristics of claims distribution for a given carrier whose performance needs to be compared and measured against sample data from other carriers. Accordingly, the disclosed technology is able to consider parameters such as vehicle features and insurance claims data to compare the performance of one carrier to another and provide an unbiased comparison.

In general, one aspect disclosed features a method comprising: obtaining, by a computing device, vehicle insurance claim data from a plurality of data sources, the data sources corresponding to a plurality of sample insurance carriers in a plurality of geographic regions, the vehicle insurance claim data specifying a vehicle data, geographic data related to the vehicle data, and time data representing time periods during which the vehicle data was recorded; categorizing, by the computing device, the obtained vehicle insurance claim data into a plurality of strata; mapping, by the computing device, the categorized vehicle insurance claim data to corresponding geographic regions; aggregating, by the computing device, the categorized vehicle insurance claim data based on the mapped geographic regions; determining, by the computing device, a sampling threshold value for sampling the aggregated vehicle insurance claim data based on one or more threshold rules; upon determining that the number of samples in the aggregated vehicle insurance claim data meets the determined sampling threshold size, clustering, by the computing device, the aggregated vehicle insurance claim data into a plurality of clusters based on at least one of the vehicle data, the geographic data, and time data according to a data clustering algorithm; generating, by the computing device, a plurality of component synthetic peer data sets by sampling the clustered aggregated vehicle insurance claim data; generating, by the computing device, a synthetic peer data set by applying a bootstrap aggregation machine learning algorithm on the plurality of component synthetic peer data sets, wherein the synthetic peer data set is more accurate and stable than the component synthetic peer data sets; analyzing, by the computing device, performance of a target vehicle insurance company by comparing target vehicle insurance claim data of the target vehicle insurance company with the synthetic peer data set; and presenting, by the computing device, results of the comparison between the target vehicle insurance claim data and the synthetic peer in a graphical representation.

Embodiments of the method may include one or more of the following features. In some embodiments, the categorizing, by the computing device, the obtained vehicle insurance data is based on one or more data categorizing rules. Some embodiments comprise performing, by the computing device, data validation to the generated sample vehicle insurance sampling data. Some embodiments comprise integrating, by the computing device, with an insurance claim application executing in the plurality of data sources to obtain the vehicle insurance claim sampling data. Some embodiments comprise generating, by the computing device, a subset of vehicle insurance data from the obtained vehicle claim data by removing invalid vehicle insurance data and vehicle insurance data including one or more null values. In some embodiments, the strata including a vehicle data stratum, a geographic data stratum, and a time data stratum.

In general, one aspect disclosed features a system, comprising: a hardware processor; and a non-transitory machine-readable storage medium encoded with instructions executable by the hardware processor to perform operations comprising: obtaining, by a computing device, vehicle insurance claim data from a plurality of data sources, the data sources corresponding to a plurality of sample insurance carriers in a plurality of geographic regions, the vehicle insurance claim data specifying a vehicle data, geographic data related to the vehicle data, and time data representing time periods during which the vehicle data was recorded; categorizing, by the computing device, the obtained vehicle insurance claim data into a plurality of strata; mapping, by the computing device, the categorized vehicle insurance claim data to corresponding geographic regions; aggregating, by the computing device, the categorized vehicle insurance claim data based on the mapped geographic regions; determining, by the computing device, a sampling threshold value for sampling the aggregated vehicle insurance claim data based on one or more threshold rules; upon determining that the number of samples in the aggregated vehicle insurance claim data meets the determined sampling threshold size, clustering, by the computing device, the aggregated vehicle insurance claim data into a plurality of clusters based on at least one of the vehicle data, the geographic data, and time data according to a data clustering algorithm; generating, by the computing device, a plurality of component synthetic peer data sets by sampling the clustered aggregated vehicle insurance claim data; generating, by the computing device, a synthetic peer data set by applying a bootstrap aggregation machine learning algorithm on the plurality of component synthetic peer data sets, wherein the synthetic peer data set is more accurate and stable than the component synthetic peer data sets; analyzing, by the computing device, performance of a target vehicle insurance company by comparing target vehicle insurance claim data of the target vehicle insurance company with the synthetic peer data set; and presenting, by the computing device, results of the comparison between the target vehicle insurance claim data and the synthetic peer in a graphical representation.

Embodiments of the system may include one or more of the following features. In some embodiments, the categorizing, by the computing device, the obtained vehicle insurance data is based on one or more data categorizing rules. In some embodiments, the operations further comprise: performing, by the computing device, data validation to the generated sample vehicle insurance sampling data. In some embodiments, the operations further comprise: integrating, by the computing device, with an insurance claim application executing in the plurality of data sources to obtain the vehicle insurance claim sampling data. In some embodiments, the operations further comprise: generating, by the computing device, a subset of vehicle insurance data from the obtained vehicle claim data by removing invalid vehicle insurance data and vehicle insurance data including one or more null values. In some embodiments, the strata including a vehicle data stratum, a geographic data stratum, and a time data stratum.

In general, one aspect disclosed features a non-transitory machine-readable storage medium encoded with instructions executable by a hardware processor of a computing component, the machine-readable storage medium comprising instructions to cause the hardware processor to perform operations comprising: obtaining, by a computing device, vehicle insurance claim data from a plurality of data sources, the data sources corresponding to a plurality of sample insurance carriers in a plurality of geographic regions, the vehicle insurance claim data specifying a vehicle data, geographic data related to the vehicle data, and time data representing time periods during which the vehicle data was recorded; categorizing, by the computing device, the obtained vehicle insurance claim data into a plurality of strata; mapping, by the computing device, the categorized vehicle insurance claim data to corresponding geographic regions; aggregating, by the computing device, the categorized vehicle insurance claim data based on the mapped geographic regions; determining, by the computing device, a sampling threshold value for sampling the aggregated vehicle insurance claim data based on one or more threshold rules; upon determining that the number of samples in the aggregated vehicle insurance claim data meets the determined sampling threshold size, clustering, by the computing device, the aggregated vehicle insurance claim data into a plurality of clusters based on at least one of the vehicle data, the geographic data, and time data according to a data clustering algorithm; generating, by the computing device, a plurality of component synthetic peer data sets by sampling the clustered aggregated vehicle insurance claim data; generating, by the computing device, a synthetic peer data set by applying a bootstrap aggregation machine learning algorithm on the plurality of component synthetic peer data sets, wherein the synthetic peer data set is more accurate and stable than the component synthetic peer data sets; analyzing, by the computing device, performance of a target vehicle insurance company by comparing target vehicle insurance claim data of the target vehicle insurance company with the synthetic peer data set; and presenting, by the computing device, results of the comparison between the target vehicle insurance claim data and the synthetic peer in a graphical representation.

Embodiments of the non-transitory machine-readable storage medium may include one or more of the following features. In some embodiments, the categorizing, by the computing device, the obtained vehicle insurance data is based on one or more data categorizing rules. In some embodiments, the operations further comprise: performing, by the computing device, data validation to the generated sample vehicle insurance sampling data. In some embodiments, the operations further comprise: integrating, by the computing device, with an insurance claim application executing in the plurality of data sources to obtain the vehicle insurance claim sampling data. In some embodiments, the operations further comprise: generating, by the computing device, a subset of vehicle insurance data from the obtained vehicle claim data by removing invalid vehicle insurance data and vehicle insurance data including one or more null values. In some embodiments, the strata including a vehicle data stratum, a geographic data stratum, and a time data stratum.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an example of a block diagram of an insurance data management computing apparatus for analyzing insurance data.

FIG. 2 is an example of a block diagram of an insurance data management computing apparatus.

FIG. 3 is an exemplary flowchart of a method for analyzing insurance data.

FIGS. 4A-4C are examples of generated synthetic peer data.

The figures are not exhaustive and do not limit the present disclosure to the precise form disclosed.

### DETAILED DESCRIPTION

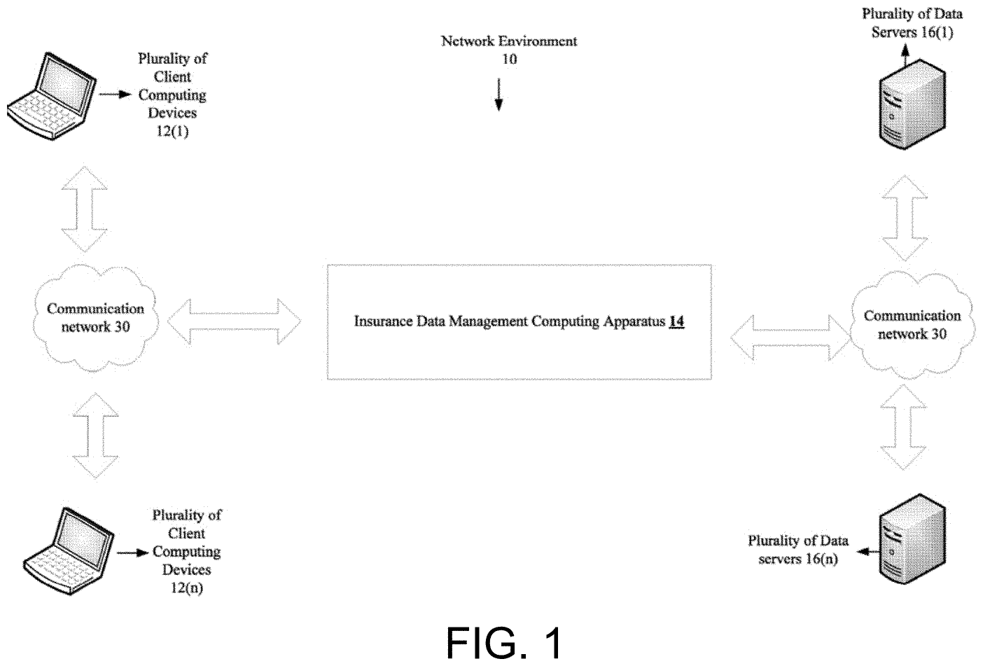

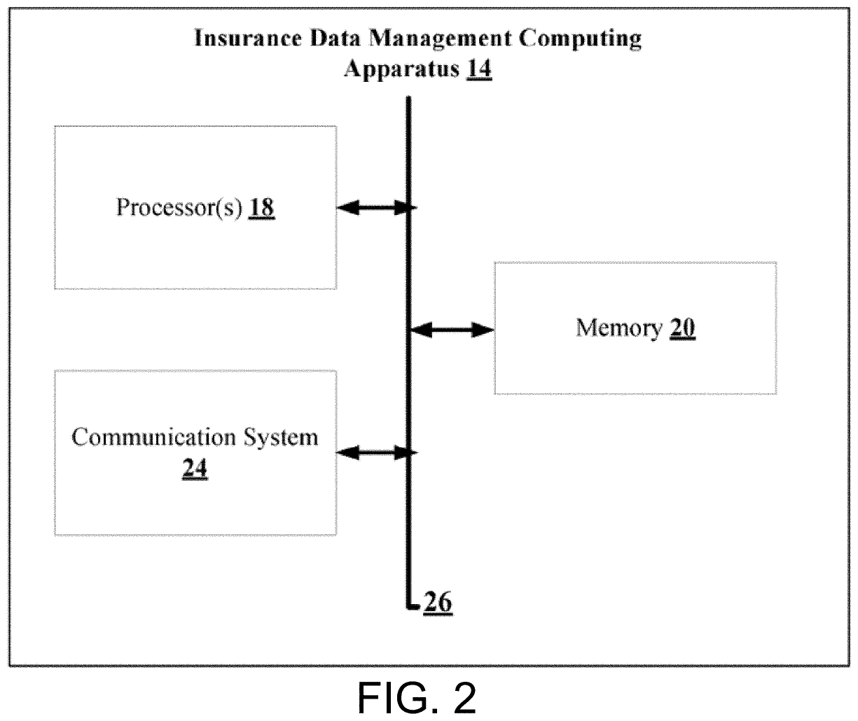

An environment 10 with an example of an insurance data management computing apparatus 14 is illustrated in FIGS. 1-2. In this particular example, the environment 10 includes the insurance data management computing apparatus 14, client computing devices 12(1)-12(n), plurality of data servers 16(1)-16(n) coupled via one or more communication networks 18, although the environment could include other types and numbers of systems, devices, components, and/or other elements as is generally known in the art and will not be illustrated or described herein. This technology provides a number of advantages including providing methods, non-transitory computer readable medium, and apparatuses to analyze insurance data. The disclosed technology is able to effectively use data from different insurance carriers in different formats to generate data that has been aggregated from accurate samples (or otherwise called synthetic peer data). Using the synthetic peer data, the disclosed technology is able to sample data with the clear understanding that the sampled data must share the same characteristics of claims distribution for a given carrier, also referred to herein as the “target carrier”, whose performance needs to be compared and measured against sample data from other carriers, also referred to herein as “sample carriers”. Accordingly, the disclosed technology is able to consider parameters such as vehicle features and insurance claims data to compare the performance of one carrier to another and provide an unbiased comparison.

Referring more specifically to FIGS. 1-2, the insurance data management computing apparatus 14 is programmed to perform efficient methods to analyze insurance data, although the apparatus can perform other types and/or numbers of functions or other operations and this technology can be utilized with other types of claims. In this particular example, the insurance data management computing apparatus 14 includes a processor 18, a memory 20, and a communication system 24 which are coupled together by a bus 26, although the insurance data management computing apparatus 14 may comprise other types and/or numbers of physical and/or virtual systems, devices, components, and/or other elements in other configurations.

The processor 18 in the insurance data management computing apparatus 14 may execute one or more programmed instructions stored in the memory 20 for improving the accuracy of automated vehicle valuations as illustrated and described in the examples herein, although other types and numbers of functions and/or other operations can be performed. The processor 18 in the insurance data management computing apparatus 14 may include one or more central processing units and/or general purpose processors with one or more processing cores, for example.

The memory 20 in the insurance data management computing apparatus 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication system 24 in the insurance data management computing apparatus 14 operatively couples and communicates between one or more of the client computing devices 12(1)-12(n) and one or more of the plurality of data servers 16(1)-16(n), which are all coupled together by one or more of the communication networks 30, although other types and numbers of communication networks or systems with other types and numbers of connections and configurations to other devices and elements may be utilized. By way of example only, the communication networks 18 can use TCPIP over Ethernet and industry-standard protocols, including NFS, CIFS, SOAP, XML, LDAP, SCSI, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the client computing devices 12(1)-12(n) may submit requests for analyzing insurance data by the insurance data management computing apparatus 14, although the requests for analyzing insurance data can be obtained by the insurance data management computing apparatus 14 in other manners and/or from other sources. Each of the client computing devices 12(1)-12(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements.

The plurality of data servers 16(1)-16(n) may store and provide data associated with different insurance carriers, by way of example only, to the insurance data management computing apparatus 14 via one or more of the communication networks 30, for example, although other types and/or numbers of storage media in other configurations could be used. In this particular example, each of the plurality of data servers 16(1)-16(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the plurality of data servers 16(1)-16(n) and may transmit data in response to requests from the insurance data management computing apparatus 14. Each the plurality of data servers 16(1)-16(n) may include a processor, a memory, and a communication interface, which are coupled together by a bus or other link, although each may have other types and/or numbers of other systems, devices, components, and/or other elements.

Although the exemplary network environment 10 with the insurance data management computing apparatus 14, the agent computing devices 12(1)-12(n), the plurality of data servers 16(1)-16(n), and the communication networks 30 are described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

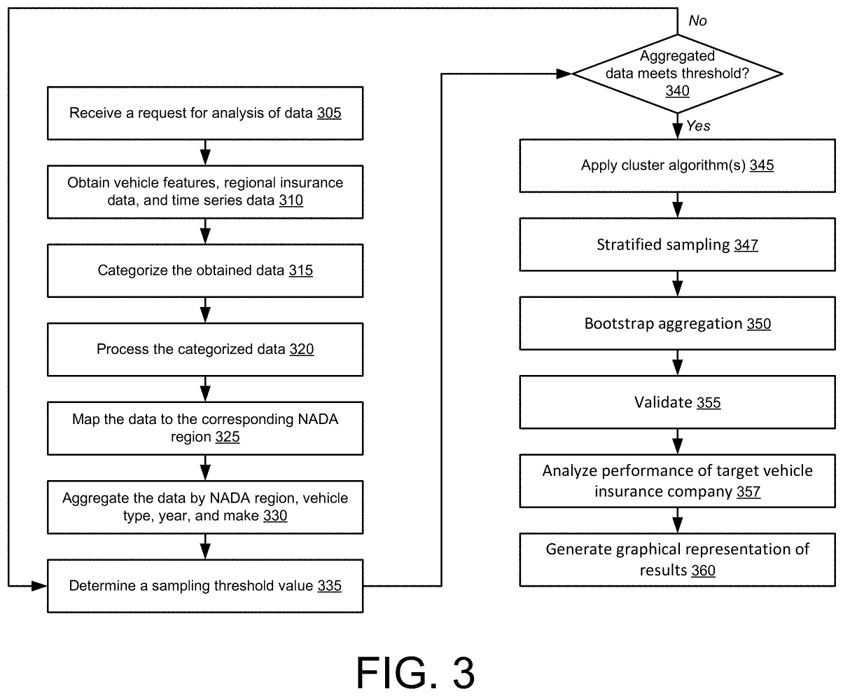

An example of a method for analyzing insurance data will now be described with reference to FIGS. 1-4C. In particular, referring to FIGS. 3A-3C the exemplary method begins at step 305 where the insurance data management computing apparatus 14 may integrate with at least one insurance claim application executed by a requesting one of the plurality of client computing devices 12(1)-12(n) to initiate analysis of insurance data of various carriers.

In step 310, the insurance data management computing apparatus 14 may obtain data related to a plurality of sample insurance carriers from the plurality of data servers 16(1)-16(n) in response to the request. The data may include any data related to insurance, for example such as vehicle features data, regional insurance claims data, time series data, and other data associated with the sample insurance carriers. The insurance data management computing apparatus 14 can obtain different types of data from different data sources. By way of example, the vehicle features includes but not limited to data associated with type, make, model and year of a vehicle, the regional insurance claims data including but not limited to the demographic regions and the ZIP codes, and the time series data including the data indexed based on the time series data which include day, week, month, quarter, and year, although the vehicle feature data, regional insurance data and the time series data can include other types or amounts of information such as like vehicle identification number data (or VIN), or demographic data including longitude latitude data. In this example, time series data relates to the insurance data points that has been recorded over a period of time. By way of example, time series data can include the data relating to the total losses recorded on each day of the year, although the time series data can include other types of information.

In step 315, the insurance data management computing apparatus 14 may categorize the obtained data for the obtained sample insurance carriers into multiple strata. For example, one strata may include vehicle data such as vehicle identification number, vehicle region, vehicle make, vehicle model, vehicle year, vehicle type, company code, and similar data. Another strata may include geographic data, for example such as demographic regions, NADA regions, zip codes, and similar data. Another strata may include time data, for example such as month, year, and similar data. Other strata may be included. By categorizing the data into strata, the disclosed technology is able to have the right set of quality data to run a statistical comparison.

Next in step 320, the insurance data management computing apparatus 14 may process the categorized data by removing invalid data or data with certain null values. By way of example, the insurance data management computing apparatus 14 may remove data with missing or default service codes, data where the service code, time period, or total estimate amount are unknown, data where the estimates amount is zero dollars, and data where the NADA region is unknown. Furthermore, the insurance data management computing apparatus 14 may remove statistical outliers from the categorized data.

Removing outliers may include the steps that follow. A frequency distribution of the target carrier data may be obtained. A frequency distribution of the sample carrier data may be obtained. A correlation of the target carrier data frequency distribution and the sample carrier data frequency distribution may be obtained. The outliers may be identified in the correlation. The identified outliers may be removed from the sample carrier data. For example, parametric and/or non-parametric techniques may be used.

In step 325, the insurance data management computing apparatus 14 may map the information present in the categorized vehicle features data, regional insurance claims data as well as time series data associated with multiple sample insurance carriers to specific geographic regions. By way of example, the insurance data management computing apparatus 14 can map the data to corresponding national automobile dealers association (NADA) regions, although the insurance data management computing apparatus 14 can map the data to specific geographic regions based on other parameters.

In step 330, the insurance data management computing apparatus 14 may aggregate the data based on one or more parameters. For example, the parameters may include geographic region, vehicle, type, year, and make, although the insurance data management computing apparatus 14 can aggregate the data using other parameters.

In step 335, the insurance data management computing apparatus 14 may determine a sampling threshold value based on one or more threshold rules, although the insurance data management computing device 14 can determine the claims threshold value using other techniques. By way of example only, the threshold rules can include the data must not reduce significantly i.e., it must be more than at least 25%; data must be big enough to do a statistical comparison typically at least more than 30; and the data must not be synthetically imputed in any way and must adhere to available industry wide data, although other types and additional rules can be included.

The thresholding may be applied to each strata to ensure every strata contains a sufficient number of samples. In some embodiments, a statistical T test may be used. When a stratum does not contain a sufficient number of samples, the strata may be adjusted. For example, that stratum may be combined with one or more other strata. In some cases, the categorization may be performed again, with different parameters, to obtain different strata. In some embodiments, machine learning techniques may be used to combine strata. The techniques may include supervised and/or unsupervised learning techniques. For example, the techniques may include principal component analysis (PCA), cluster analysis, stochastic gradient descent (SGD), central limit theorem techniques, and similar techniques.

Next in step 340, the insurance data management computing apparatus 14 may determine if the aggregated data meets the determined sampling threshold value. In this example, the insurance data management computing apparatus 14 may determines if the aggregated data meets the determined sampling threshold value to ensure that there is appropriate amount of sample data available for processing. Accordingly, when the insurance data management computing apparatus 14 determines that the aggregated data does not meet the determined sampling threshold value, then the No branch is taken to step 339 where the aggregation of the data may be reconsidered. However, if the insurance data management computing apparatus 14 determines that the aggregated data meets the determined threshold value, then the Yes branch is taken to step 345. In this example, determining whether the aggregated data meets the determined sampling threshold value is important because the insurance data management computing apparatus 14 can aggregate sufficient data for accurately generating statistical data for comparison.

In step 345, the insurance data management computing apparatus 14 may apply one or more cluster algorithms to the aggregated data. By way of example, the insurance data management computing apparatus 14 can apply bootstrap aggregation as one of the cluster algorithms, although the insurance data management computing apparatus 14 can apply other types of cluster algorithms. By applying one of the data clustering algorithms, the disclosed technology may cluster the aggregated data based on the vehicle data, geographic data and time series data, although the data can be clustered into different models. In some embodiments, the insurance data management computing apparatus 14 may obtain a list of service lines and corresponding attributes, and may group the service lines according to the created clusters.

In step 347, the insurance data management computing apparatus 14 may perform stratified sampling of the data. For example, the sampling may obtain samples from multiple strata of the data. The sampling may continue until a predetermined number of statistically significant samples is obtained with a selected alpha threshold value. In one embodiment, the sampling may continue until 35 statistically significant samples is obtained, with an alpha of 0.05. The sampling may be applied to generate multiple sets of data, each referred to herein as a “component synthetic peer data set”. In one embodiment, 35 component synthetic peer data sets are generated.

In step 350, the insurance data management computing apparatus 14 may perform bootstrap aggregation on the aggregated data to generate data that can be used for comparison (also referred to herein as a “synthetic peer data set”). In this example, bootstrap aggregation may relate to applying algorithms to improve the stability and accuracy of the data while performing analytics. Further, the synthetic aggregation of data that is generated may include a portion of the data that was obtained in the step 310 and the data then is ready for applying the statistical model and comparing to another data set. By way of example, the synthetic aggregation of data can include data associated with the model, make, year of the vehicle, the geographical location of the vehicle (or the vehicle region) and the time series data of the vehicle for a specific insurance carrier, although the synthetic aggregation of data can include other types or amounts of information.

In some embodiments, the bootstrap aggregating includes aggregating multiple component synthetic peer data sets to generate a single synthetic peer data set. One or more machine learning models may be employed. For example, the machine learning models and techniques may include decision trees, neural networks, gradient boosting, and similar machine learning models and techniques. The machine learning models may be trained previously according to historical correspondences between inputs and corresponding known outputs. The training may be supervised, unsupervised, or a combination thereof. The machine learning models may employ one or more voting techniques to obtain a voting result.

Next in step 355, the insurance data management computing apparatus 14 may validate the generated synthetic aggregation of data. By way of example, the insurance data management computing apparatus 14 performs a statistical T-test validation within each strata of the synthetical aggregation to make sure the samples represent the actual population, although the insurance data management computing apparatus 14 can use other techniques for data validation. In this example, only an exact equality will lead to a p-value of 1.0, which is conforming to each strata of the sample that represents the actual population. Optionally in this example, when the data validation fails, the exemplary flow can proceed back to step 335 where the sampling threshold size can be redetermined.

In step 357, the insurance data management computing apparatus 14 may analyze performance of a target vehicle insurance company by comparing target vehicle insurance claim data of the target vehicle insurance company with the synthetic peer data set.

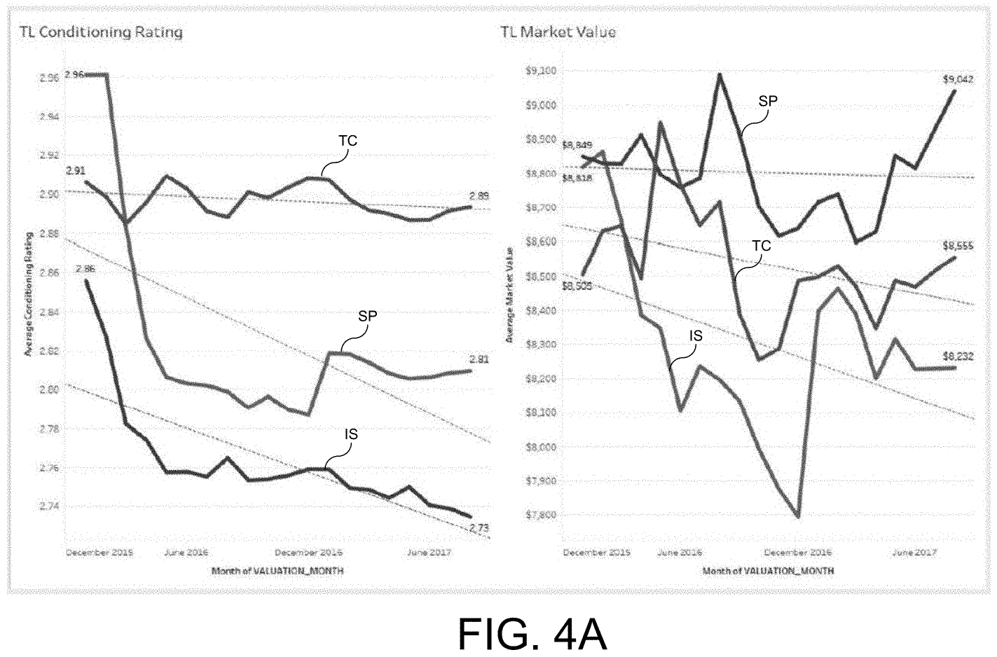

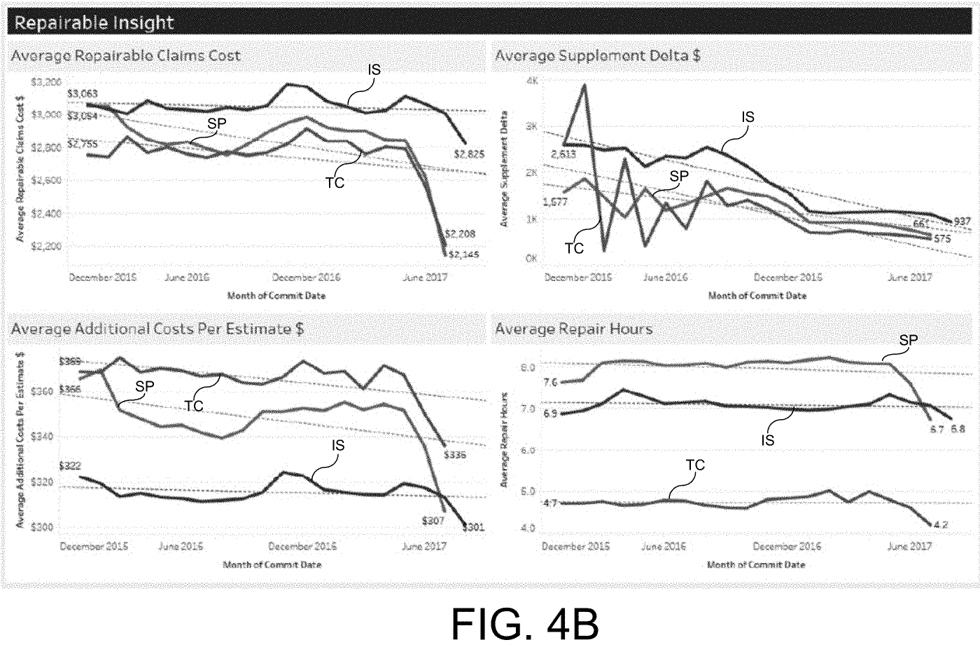

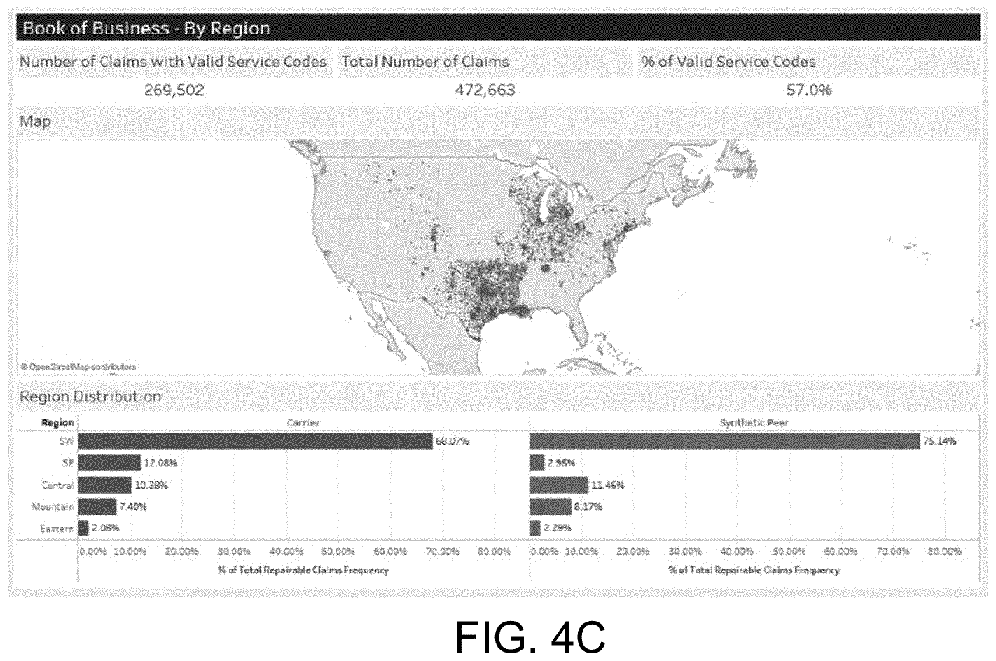

In step 360, the insurance data management computing apparatus 14 may generate results of the comparison between the target vehicle insurance claim data and the synthetic peer in a graphical representation. In this example, the graphical representation can include the insights of the synthetic aggregation of the data, although the graphical representation can include other types or amounts of information. In this example, FIGS. 4A-4C illustrate an example graphical representation. In FIGS. 4A and 4B, the target carrier is denoted TC, the synthetic peer is denoted SP, and the industry average is denoted IA. Additionally in this example, the synthetic peer data that is generated is transferred to a cache memory within the memory 20 and the graphical representation is created based on the data in the cache memory. By using this technique, the disclosed technology is able to provide a faster and real-time representation of the data without latency. The exemplary method ends at step 365.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method comprising:
obtaining, by a computing device, vehicle insurance claim data from a plurality of data sources, the data sources corresponding to a plurality of sample insurance carriers in a plurality of geographic regions, the vehicle insurance claim data specifying a vehicle data, geographic data related to the vehicle data, and time data representing time periods during which the vehicle data was recorded;
categorizing, by the computing device, the obtained vehicle insurance claim data into a plurality of strata;
mapping, by the computing device, the categorized vehicle insurance claim data to corresponding geographic regions;
aggregating, by the computing device, the categorized vehicle insurance claim data based on the mapped geographic regions;
determining, by the computing device, a sampling threshold value for sampling the aggregated vehicle insurance claim data based on one or more threshold rules;
upon determining that the number of samples in the aggregated vehicle insurance claim data meets the determined sampling threshold size, clustering, by the computing device, the aggregated vehicle insurance claim data into a plurality of clusters based on at least one of the vehicle data, the geographic data, and time data according to a data clustering algorithm;
generating, by the computing device, a plurality of component synthetic peer data sets by sampling the clustered aggregated vehicle insurance claim data;
generating, by the computing device, a synthetic peer data set by applying a bootstrap aggregation machine learning algorithm on the plurality of component synthetic peer data sets, wherein the synthetic peer data set is more accurate and stable than the component synthetic peer data sets;
analyzing, by the computing device, performance of a target vehicle insurance company by comparing target vehicle insurance claim data of the target vehicle insurance company with the synthetic peer data set; and
presenting, by the computing device, results of the comparison between the target vehicle insurance claim data and the synthetic peer in a graphical representation.

2. The method of claim 1, wherein the categorizing, by the computing device, the obtained vehicle insurance data is based on one or more data categorizing rules.

3. The method of claim 1, further comprising:
performing, by the computing device, data validation to the generated sample vehicle insurance sampling data.

4. The method of claim 1 further comprising:
integrating, by the computing device, with an insurance claim application executing in the plurality of data sources to obtain the vehicle insurance claim sampling data.

5. The method of claim 1 further comprising:
generating, by the computing device, a subset of vehicle insurance data from the obtained vehicle claim data by removing invalid vehicle insurance data and vehicle insurance data including one or more null values.

6. The method of claim 1, wherein the strata including a vehicle data stratum, a geographic data stratum, and a time data stratum.

7. A system, comprising:
a hardware processor; and
a non-transitory machine-readable storage medium encoded with instructions executable by the hardware processor to perform operations comprising:
obtaining, by a computing device, vehicle insurance claim data from a plurality of data sources, the data sources corresponding to a plurality of sample insurance carriers in a plurality of geographic regions, the vehicle insurance claim data specifying a vehicle data, geographic data related to the vehicle data, and time data representing time periods during which the vehicle data was recorded;
categorizing, by the computing device, the obtained vehicle insurance claim data into a plurality of strata;
mapping, by the computing device, the categorized vehicle insurance claim data to corresponding geographic regions;
aggregating, by the computing device, the categorized vehicle insurance claim data based on the mapped geographic regions;
determining, by the computing device, a sampling threshold value for sampling the aggregated vehicle insurance claim data based on one or more threshold rules;
upon determining that the number of samples in the aggregated vehicle insurance claim data meets the determined sampling threshold size, clustering, by the computing device, the aggregated vehicle insurance claim data into a plurality of clusters based on at least one of the vehicle data, the geographic data, and time data according to a data clustering algorithm;
generating, by the computing device, a plurality of component synthetic peer data sets by sampling the clustered aggregated vehicle insurance claim data;
generating, by the computing device, a synthetic peer data set by applying a bootstrap aggregation machine learning algorithm on the plurality of component synthetic peer data sets, wherein the synthetic peer data set is more accurate and stable than the component synthetic peer data sets;
analyzing, by the computing device, performance of a target vehicle insurance company by comparing target vehicle insurance claim data of the target vehicle insurance company with the synthetic peer data set; and
presenting, by the computing device, results of the comparison between the target vehicle insurance claim data and the synthetic peer in a graphical representation.

8. The system of claim 7, wherein the categorizing, by the computing device, the obtained vehicle insurance data is based on one or more data categorizing rules.

9. The system of claim 7, the operations further comprising:
performing, by the computing device, data validation to the generated sample vehicle insurance sampling data.

10. The system of claim 7, the operations further comprising:
integrating, by the computing device, with an insurance claim application executing in the plurality of data sources to obtain the vehicle insurance claim sampling data.

11. The system of claim 7, the operations further comprising:
generating, by the computing device, a subset of vehicle insurance data from the obtained vehicle claim data by removing invalid vehicle insurance data and vehicle insurance data including one or more null values.

12. The system of claim 7, wherein the strata including a vehicle data stratum, a geographic data stratum, and a time data stratum.

13. A non-transitory machine-readable storage medium encoded with instructions executable by a hardware processor of a computing component, the machine-readable storage medium comprising instructions to cause the hardware processor to perform operations comprising:
obtaining, by a computing device, vehicle insurance claim data from a plurality of data sources, the data sources corresponding to a plurality of sample insurance carriers in a plurality of geographic regions, the vehicle insurance claim data specifying a vehicle data, geographic data related to the vehicle data, and time data representing time periods during which the vehicle data was recorded;
categorizing, by the computing device, the obtained vehicle insurance claim data into a plurality of strata;
mapping, by the computing device, the categorized vehicle insurance claim data to corresponding geographic regions;
aggregating, by the computing device, the categorized vehicle insurance claim data based on the mapped geographic regions;
determining, by the computing device, a sampling threshold value for sampling the aggregated vehicle insurance claim data based on one or more threshold rules;
upon determining that the number of samples in the aggregated vehicle insurance claim data meets the determined sampling threshold size, clustering, by the computing device, the aggregated vehicle insurance claim data into a plurality of clusters based on at least one of the vehicle data, the geographic data, and time data according to a data clustering algorithm;
generating, by the computing device, a plurality of component synthetic peer data sets by sampling the clustered aggregated vehicle insurance claim data;
generating, by the computing device, a synthetic peer data set by applying a bootstrap aggregation machine learning algorithm on the plurality of component synthetic peer data sets, wherein the synthetic peer data set is more accurate and stable than the component synthetic peer data sets;
analyzing, by the computing device, performance of a target vehicle insurance company by comparing target vehicle insurance claim data of the target vehicle insurance company with the synthetic peer data set; and
presenting, by the computing device, results of the comparison between the target vehicle insurance claim data and the synthetic peer in a graphical representation.

14. The non-transitory machine-readable storage medium of claim 13, wherein the categorizing, by the computing device, the obtained vehicle insurance data is based on one or more data categorizing rules.

15. The non-transitory machine-readable storage medium of claim 13, the operations further comprising:
performing, by the computing device, data validation to the generated sample vehicle insurance sampling data.

16. The non-transitory machine-readable storage medium of claim 13, the operations further comprising:
integrating, by the computing device, with an insurance claim application executing in the plurality of data sources to obtain the vehicle insurance claim sampling data.

17. The method of claim 13, the operations further comprising:
generating, by the computing device, a subset of vehicle insurance data from the obtained vehicle claim data by removing invalid vehicle insurance data and vehicle insurance data including one or more null values.

18. The non-transitory machine-readable storage medium of claim 13, wherein the strata including a vehicle data stratum, a geographic data stratum, and a time data stratum.
